(19) United States
(12) Patent Application Publication
(10) Pub. No.: US 2007/0074434 A1
(43) Pub. Date: Apr. 5, 2007

(54) Note and photo organizing system

(76) Inventor: Rick D. Johnson, Mill Valley, CA (US)

Correspondence Address: BUCHANAN, INGERSOLL & ROONEY PC, POST OFFICE BOX 1404, ALEXANDRIA, VA, 22313-1404, US

(21) Appl. No.: 11/203,616

(22) Filed: Aug. 12, 2005

(51) Int. Cl. G09F 7/00; A47F 7/16; A47B 96/06; A47F 5/08; A47F 5/00; A47H 1/10; E04G 3/00

(52) U.S. Cl. 40/611.1; 248/205.1; 211/45

(57) ABSTRACT

A note and photo organizing system configured to extend around at least a substantial portion of a perimeter of an object, having: a first portion dimensioned to extend in a perpendicular direction from the perimeter of the object; and a second portion extending in a direction perpendicular to the first portion, such that the second portion is positioned in front of the object such that the system forms a pocket extending around at least a substantial portion of the perimeter of the object. A plurality of clips are connected to the second portion of the system such that articles held by the clips are positioned to extend outwardly away from the system such that they do not cover a viewing surface of the object.

### TECHNICAL FIELD

In one particular embodiment, the present invention relates to a whiteboard frame for organizing notes and photographs on the front of a refrigerator. The present invention also relates to systems for displaying notes and photos on the edges of computer monitors.

### BACKGROUND OF THE INVENTION

Clutter is a problem in most households, and in most offices. This problem is especially pronounced when attempting to organize various handwritten notes and memos, printed advertisements, business cards, and children's drawings.

In many households, the refrigerator becomes the central organizing point, and also the place where children's artwork is displayed. Unfortunately, the refrigerator tends to become cluttered with various notes, memos, photos and artwork held in place by magnets. The same sort of problem exists in offices where corkboards are the central organizing point. Things get lost.

What is instead desired is an organizing system which holds notes, memos and photographs in an easy to read, well organized format so that they do not get lost. In addition, it would also be convenient to provide a convenient location for a user both to write and to display written notes or messages.

### SUMMARY OF THE INVENTION

The present invention provides a note and photo organizing system configured to extend around at least a substantial portion of a perimeter of an object, wherein the system includes: a first portion dimensioned to extend in a perpendicular direction from the perimeter of the object; and a second portion extending in a direction perpendicular to the first portion, such that the second portion is positioned in front of the object such that the system forms a pocket extending around at least a substantial portion of the perimeter of the object. As such, the second portion extends inwardly toward the center of the system, covering a portion of the surface of the object. In various embodiments, the system is a frame, but is not so limited.

In an alternate embodiment, the present invention provides a note and photo organizing system configured to extend around at least a substantial portion of a perimeter of an object, wherein the system includes: a body extending around at least a substantial portion of the perimeter of the object; and a clipping mechanism connected to the body, wherein the clipping mechanism is configured to grasp onto articles such that the articles extend outwardly away from the body such that the articles do not cover a viewing surface of an object positioned within the frame. The clipping mechanism may be moveable with respect to the object such that an end of the article can be inserted under a portion of the clipping mechanism. In preferred embodiments, the member is pivotable with respect to the object, and it comprises a spring which causes the member to grasp onto the article. In preferred embodiments, the clipping mechanism extends along a substantial portion of a side of the body.

In an alternate embodiment, the present invention provides a note and photo organizing system configured to extend along an edge of an object, wherein the system includes: a body extending along at least a portion of the perimeter of the object; and a clipping mechanism connected to the body, wherein the clipping mechanism is configured to grasp onto articles such that the articles extend outwardly away from the frame such that the articles do not cover a viewing surface of the object. The clipping mechanism may be moveable with respect to the object such that an end of the article can be inserted under a portion of the clipping mechanism.

In preferred embodiments, the object is an erasable white board. In various embodiments, the whiteboard may, or may not be, magnetic. Thus, the first portion of the frame extends perpendicular to the erasable white board and a second portion extends parallel to the erasable white board. In alternate embodiments, the object may be a chalkboard, a corkboard, a computer terminal or a mirror. Other possibilities for the object are also contemplated, all keeping within the scope of the present invention.

An advantage of the present invention is that it can be used to display various notes, photos, business cards, etc. around the perimeter of the object such that the various notes, photos, business cards, etc. do not block the viewing or writing surface of the object. Instead, the various notes, photos, business cards, etc. are held in a convenient location at the edge of the system (for easy viewing and organization) while extending outwardly away from the center of the object (so as not to cover the object's viewing or writing surface).

Another advantage of the present invention is that it forms a pocket in which pens or markers can be stored for use with objects such as whiteboards or chalkboards. Alternately, such a pocket can be used to store push pins when the object is a corkboard.

Another advantage of the present invention is that is serves as a mounting location for the various clips that hold the notes, photos, business cards, etc. to the frame. Moreover, the various clips can be moved to different locations around the object, as desired. Thus, notes, photos, business cards, etc. of different sizes (and different weights) can be displayed at various places around the object, as desired.

### BRIEF DESCRIPTION OF THE DRAWINGS

FIG. 1 is a front elevation view of the present invention holding a variety of memos, photos and business cards.

FIG. 2 is a sectional plan view of the present invention taken along line 2-2 in FIG. 1.

FIG. 3 is a section elevation view of the present invention taken along line 3-3 in FIG. 1.

FIG. 4 is an alternate sectional plan view of a portion of the present invention taken along line 2-2 in FIG. 1.

FIG. 5 is another alternate sectional plan view of a portion of the present invention taken along line 2-2 in FIG. 1.

FIG. 6 is another alternate sectional plan view of a portion of the present invention.

FIG. 7 is a view similar to FIG. 4, but with the second portion of the frame member angled with respect to the object in the frame.

FIG. 8 is a sectional view of an alternate embodiment of the invention.

### DETAILED DESCRIPTION OF THE DRAWINGS

In one embodiment, the present invention provides an erasable white board, note and photo organizing system. In another embodiment, the present invention can be used as a frame around a chalkboard, corkboard, mirror, computer terminal, or other object. In yet another embodiment, the present invention can be fastened onto one or more of the sides of the computer terminal, or any other object.

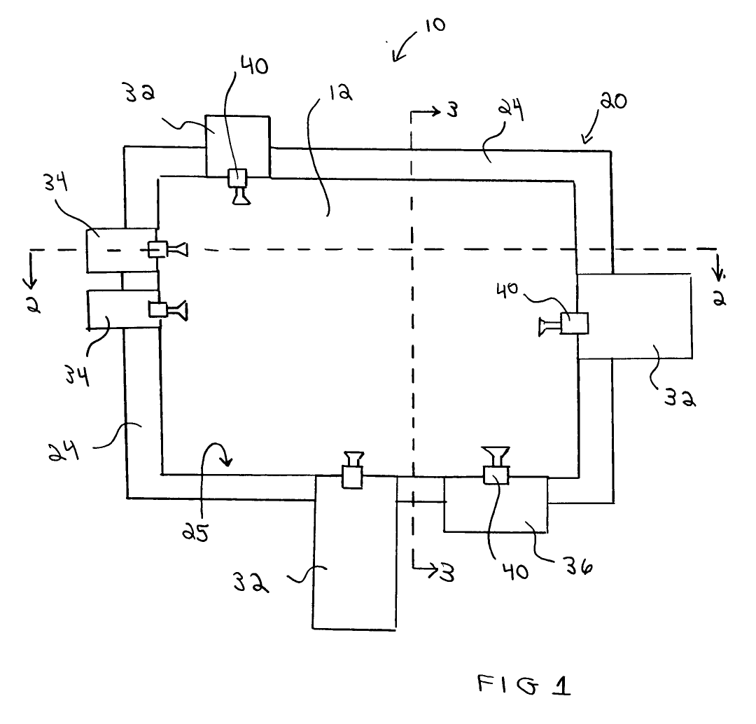

FIG. 1 illustrates the present note and photo organizing system 10, as follows. An object 12 is provided. Object 12 may be an erasable white board, a chalkboard, corkboard, mirror, or other object. Frame 20 extends around at least a substantial portion of a perimeter of object 12.

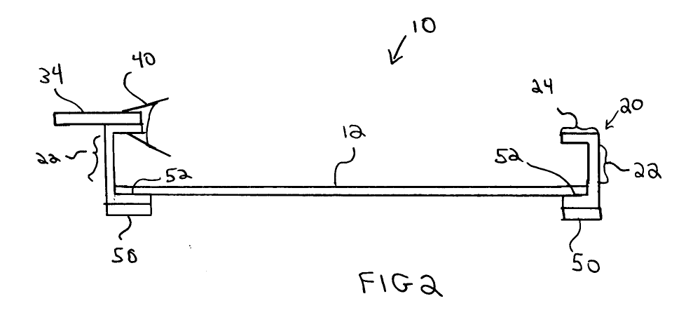

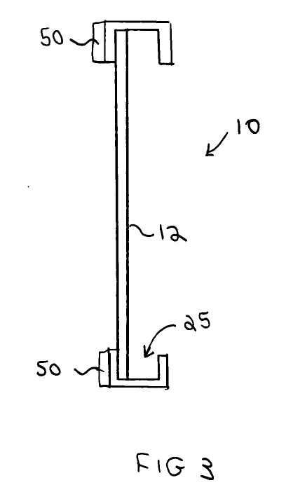

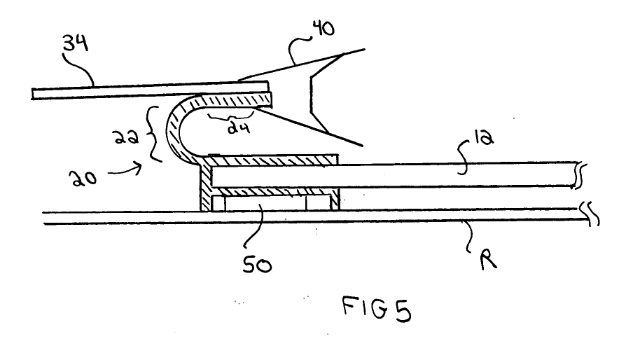

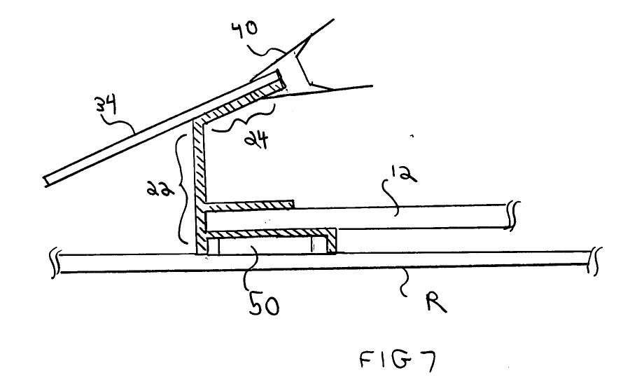

As seen in FIG. 2, frame 20 includes a first portion 22 extending in a direction perpendicular to object 12 and a second portion 24 extending in a direction parallel to object 12. As can be seen, second portion 24 of frame 20 is disposed directly in front of the object 12 such that frame 20 forms a pocket 25 (See FIG. 3) extending around at least a substantial portion of the perimeter of object 12. It is to be understood that first portion 22 need not be a straight member positioned exactly perpendicular to object 12. Rather, first portion 22 need only extend in a direction perpendicular (i.e.: away from) object 12. In addition, it is to be understood that second portion 24 need not be positioned exactly perpendicular to first portion 22. As a result, the presently claimed invention encompasses embodiments including the embodiment illustrated in FIG. 5, where, for example, a curved, angled or C-shaped frame member(s) 20 provides an edge or surface 24 that is positioned away from object 12. Thus, the first portion 22 and second portion 24 may provided by a single continuous curved, angled or C-shaped frame member. In addition, it is to be understood that second portion 24 need not be a straight member positioned exactly parallel to object 12. Rather, second portion 24 need only extend in a direction that is parallel to the surface of object 12. An example is seen in FIG. 7, wherein second portion 24 is positioned at an angle (i.e.: not parallel) to object

As illustrated, object 12 (and frame 20) may be rectangular. In a preferred embodiment, object 12 (and frame 20) is square. It is to be understood, however, that the present invention is not limited to any particular shape of object 12 and frame 20. For example, designs with three sides (i.e. triangular) and designs with more than four sides (e.g.: octagonal) are also contemplated. Moreover, designs with a curved (e.g.: circular or oval) object 12 and curved (e.g.: circular or oval) frame 20 are also contemplated within the scope of the present invention.

As can be seen in FIGS. 1 and 2, frame 20 can be used to hold various objects including photograph 32, memo note 34 and business card 36. As can be seen, each of photograph 32, memo note 34 and business card 36 are supported such that they do not block the writing or viewing surface of object 12. This is achieved by having second portion 24 of frame 20 extend inwardly such that a clip 40 can be used to hold the photograph, memo or business card (e.g. memo note 34 in FIG. 2).

As can be seen, regardless of which position clips 40 are mounted to second portion 24, the article (photograph 32, memo note 34 or business card 36) that are held by clip(s) 40 will be positioned such that they extend outwardly away from object 12, and do not block the viewing/writing surface of object 12.

Another advantage of the present frame invention is that clips 40 can easily be moved to any convenient location around the edge of second portion 24. Thus, the operator has the ability to organize their photograph(s) 32, memo note(s) 34 and business card 36(s) at any location around the edge of the frame as they see fit.

Clips 40 are not limited to any particular embodiment of clip, any may comprise binder clips, clothes pins or paper clips.

In one preferred embodiment of the invention, first portion 22 of frame 20 is from ⅛ to 2 inches in length. Thus, second portion 24 of frame 20 is positioned ⅛ to 2 inches away from object 12. In this preferred embodiment of the invention, second portion 24 of frame 20 is from ⅛ to 2 inches in length. This particular embodiment of the invention is particularly well suited for use when clips 40 are standard binder clips.

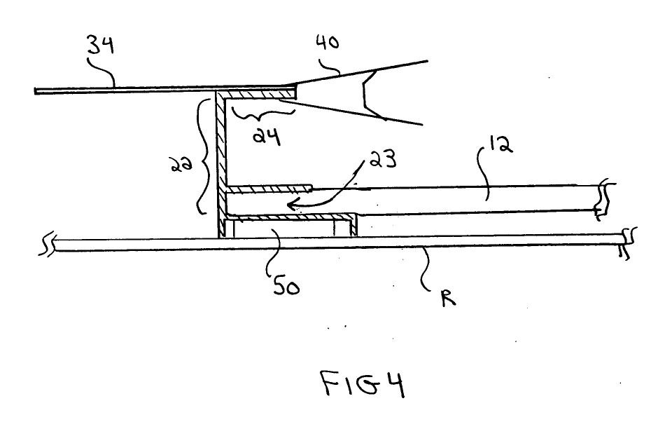

As seen in FIG. 2, magnets 50 can be mounted on the back of object 12. Note: double-sided adhesive tape can be used instead of magnets in any of the embodiments of the invention presented herein. In this particular embodiment of the invention, system 10 is ideally suited for use on a refrigerator. In alternate embodiments, top or side hook(s) may also be used to attached the present frame directly to a wall. In one preferred embodiment, object 12 can be mounted to frame 20 by adhesive tape 52, however, the present invention is not so limited. For example, as seen in FIG. 4, object 12 may be inserted into a slot 23 extending theraround. (Optional magnet 50 and the front of refrigerator R are also illustrated for clarity.)

In preferred embodiments, frame 20 extends around the entire perimeter of object 12, as seen in FIG. 1. An advantage of such a design is that the present invention can be placed onto the front of a refrigerator in any orientation. IE: in the case of a rectangular object 12, the user can mount the system lengthwise or widthwise, as desired. In either case, frame 20 will still form the pocket 25 (FIG. 3) at the bottom of the device in which markers, pens, push pins, etc. can be stored. It is to be understood, however, that frame 20 need not be positioned to extend fully around all the sides of object 12.

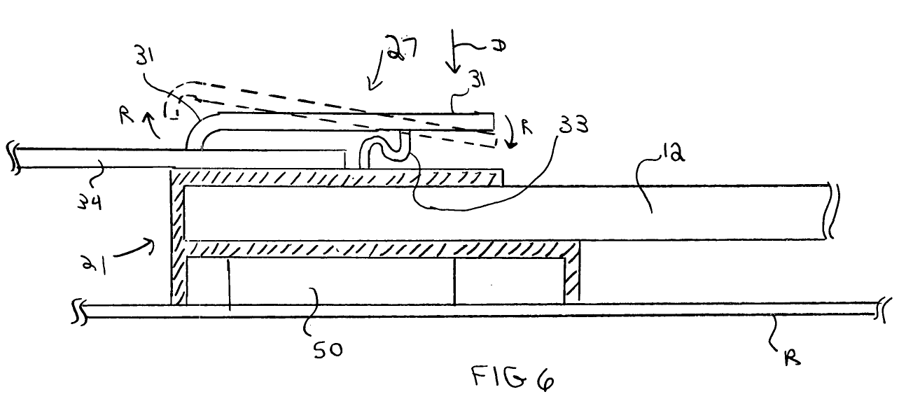

FIG. 6 shows an alternate embodiment of the invention where frame body 21 extends around at least a substantial portion of the perimeter of object 12; and a clipping mechanism 27 is connected to frame body 21. Clipping mechanism 27 is configured to grasp onto articles (e.g.: note 34) such that the articles extend outwardly away from frame 21 such that the articles do not cover a viewing surface of object 12 positioned within frame 21. As can be seen, clipping mechanism 27 may include a moveable member 31 and a spring 33. In operation, a user simply pushes down in direction D to cause member 31 to rotate in direction R (to the final position shown in dotted lines) such that an end of note 34 can be received thereunder. When released, spring 33 will cause member 31 to rotate back into position to hold the edge of note 34.

In alternate embodiments, clipping mechanism 27 may extend a short distance along a side of frame 20, or clipping mechanism 27 may extend along a substantial portion of a side of frame 20. Thus, a clipping mechanism 27 extending a short distance along a side of frame 20 may operate similar to clip 40, but at a fixed location. Alternately, clipping mechanism 27 may extend along a substantial portion (or even the entire length) of a side of frame 20. In such an embodiment, various articles can be attached at any desired location along the length of a side of frame 20, using a single clipping mechanism 27, as desired.

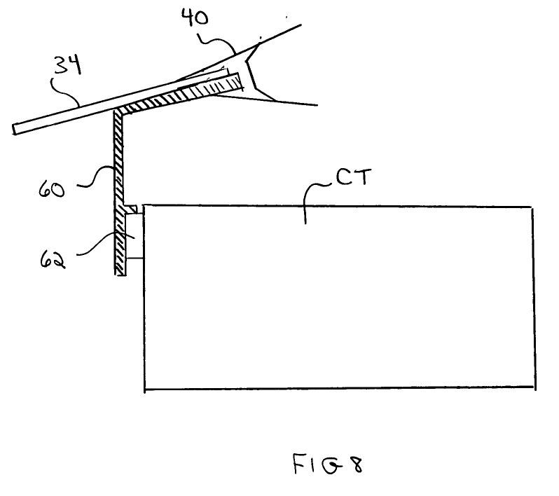

FIG. 8 shows an alternate embodiment of the invention in which body 60 extends along at least a portion of the perimeter of the object (for example, computer terminal CT). A clip 40 is connected to body 60 to grasp onto articles such as photo 34 such that photo 34 extends outwardly away from computer terminal CT such that photo 34 does not cover a viewing surface of computer terminal CT. Clip 40 may be moveable with respect to the object such that an end of the article can be inserted under a portion of the clipping mechanism.

What is claimed is:

1. A note and photo organizing system configured to extend around at least a substantial portion of a perimeter of an object, wherein the system comprises:
a first portion dimensioned to extend in a perpendicular direction from the perimeter of the object; and
a second portion extending in a direction perpendicular to the first portion, such that the second portion is positioned in front of the object such that the system forms a pocket extending around at least a substantial portion of the perimeter of the object.

2. The system of claim 1, wherein the object is an erasable white board.

3. The system of claim 1, wherein the object is a mirror.

4. The system of claim 1, wherein the object is a chalkboard.

5. The system of claim 1, wherein the object is a corkboard.

6. The system of claim 1, wherein the object is rectangular.

7. The system of claim 1, wherein the object is square.

8. The system of claim 1, wherein the first portion of the system is from ⅛ to 2 inches in length.

9. The system of claim 1, wherein the second portion of the system is from ⅛ to 2 inches in length.

10. The system of claim 1, wherein the second portion of the system is positioned ⅛ to 2 inches away from the object.

11. The system of claim 1, wherein the system extends around the entire perimeter of the object.

12. The system of claim 1, further comprising:
a plurality of clips, wherein the clips are dimensioned to grasp onto the second portion of the system such that articles held by the clips are positioned to extend outwardly away from the system such that they do not cover a viewing surface of the object.

13. The system of claim 1, further comprising:
a magnetic attachment surface mounted onto a rear side of the object.

14. A note and photo organizing system, comprising:
an object; and
a body extending around at least a substantial portion of a perimeter of the object, wherein the body comprises a member includes a first portion disposed perpendicular to the object and a second portion disposed parallel to the object, and wherein the second portion of the body is disposed directly in front of the object such that the system forms a pocket extending around at least a substantial portion of a perimeter of the object.

15. The note and photo organizing system of claim 14, wherein the object is an erasable white board.

16. The note and photo organizing system of claim 14, wherein the object is one of a mirror, a chalkboard, and a corkboard.

17. The system of claim 14, wherein the object is rectangular.

18. The system of claim 14, wherein the object is square.

19. The system of claim 14, wherein the first portion of the system is from ⅛ to 2 inches in length.

20. The system of claim 14, wherein the second portion of the system is from ⅛ to 2 inches in length.

21. The system of claim 14, wherein the second portion of the system is positioned ⅛ to 2 inches away from the object.

22. The system of claim 14, wherein the system extends around the entire perimeter of the object.

23. The system of claim 14, further comprising:
a plurality of clips, wherein the clips are dimensioned to grasp onto the second portion of the system such that articles held by the clips are positioned to extend outwardly away from the system such that they do not cover a viewing surface of the object.

24. The system of claim 14, wherein the articles are pieces of paper.

25. The system of claim 14, wherein the articles are photographs.

26. The system of claim 14, wherein the system is attached to the object with adhesive tape.

27. The system of claim 14, wherein an edge of the object is received within a slot in the system.

28. The system of claim 14, further comprising:
a magnetic attachment surface mounted onto a rear side of the object.

29. A note and photo organizing system configured to extend around at least a substantial portion of a perimeter of an object, wherein the system comprises:
a body extending around at least a substantial portion of the perimeter of the object; and
a clipping mechanism connected to the body, wherein the clipping mechanism is configured to grasp onto articles such that the articles extend outwardly away from the body such that the articles do not cover a viewing surface of an object positioned within the body.

30. The system of claim 29, wherein the clipping mechanism comprises:
a member that is moveable with respect to the object such that an end of the article can be inserted under a portion of the clipping mechanism.

31. The system of claim 30, wherein the member is pivotable with respect to the object, and wherein the member comprises a spring which causes the member to grasp onto the article.

32. The system of claim 29, wherein the clipping mechanism extends along a substantial portion of a side of the body.

33. A note and photo organizing system configured to extend along an edge of an object, wherein the system comprises:
a body extending along at least a portion of the perimeter of the object; and
a clipping mechanism connected to the body, wherein the clipping mechanism is configured to grasp onto articles such that the articles extend outwardly away from the body such that the articles do not cover a viewing surface of the object.

34. The system of claim 33, wherein the object is a computer terminal.

35. The system of claim 33, wherein the body comprises:
a first portion dimensioned to extend in a perpendicular direction from the perimeter of the object; and
a second portion extending in a direction perpendicular to the first portion, such that the second portion is positioned in front of the object such that the system forms a pocket

36. The system of claim 35, wherein the first portion of the system is from ⅛ to 2 inches in length.

37. The system of claim 35, wherein the second portion of the system is from ⅛ to 2 inches in length.

38. The system of claim 35, wherein the second portion of the system is positioned ⅛ to 2 inches away from the object.
